(19) United States
(12) Patent Application Publication
(10) Pub. No.: US 2015/0123056 A1
(43) Pub. Date: May 7, 2015

(54) TACKLE FOR DISPLACING A LOAD

(71) Applicant: Daniel Andrew HAWKINS, Emerald, QLD (AU)

(72) Inventors: Daniel Andrew Hawkins, Emerald (AU); Bradley John Ivey, Emerald (AU)

(21) Appl. No.: 14/367,798

(22) PCT Filed: Dec. 17, 2012
(86) PCT No.: PCT/AU2012/001548

§ 371 Date: Jun. 20, 2014

(30) Foreign Application Priority Data
Dec. 20, 2011 (AU) 2011905309

(51) Int. Cl. B66D 3/20; B66D 1/54; B66D 3/02; B66D 1/08; B66D 1/04; B66D 1/44; B66D 1/22; B66D 1/02

(52) U.S. Cl. CPC B66D 3/20; B66D 1/22; B66D 1/54; B66D 1/02; B66D 1/08; B66D 1/04; B66D 1/44; B66D 3/02
USPC 254/339; 254/361

(57) ABSTRACT

The disclosed tackle for displacing a load includes a hydraulic motor assembly for displacing a tensile member that is connectable to the load and a hydraulic pump assembly to drive the hydraulic motor, which hydraulic pump assembly is manually operable for driving the pump.

### FIELD OF THE INVENTION

This invention generally relates to a tackle for displacing a load and more particularly to a tackle for displacing a load using a drive assembly for a manually or hand operated hoist.

### BACKGROUND OF THE INVENTION

Tackles, such as hoists, chain blocks and the like are widely used to lift and lower heavy loads. The hoist can be permanently mounted, such as to a trolley, or can be portable and mounted using a hook or lug to a support structure. Hoists can be powered by hand, or by electricity, or by pneumatics, depending on the configuration and intended use. Conventional manually or hand-operated tackles have drawbacks in regards to safety and general operation.

One type of hoist is a lever operated hoist, also referred to as a “come-a-long”. The hoist uses a lever or handle which is reciprocated to raise and/or lower the load. The typical lever operated hoist includes a frame supporting a lifting medium such as a chain, rope or insulated strap wound about a drum. A braking mechanism, typically a ratchet and pawl, is used to maintain the hoist in a desired position during use.

There is therefore an ongoing need for alternative manually or hand-operated tackles that alleviates at least some of the drawbacks of conventional manually or hand-operated tackles.

It should be noted that reference to the prior art herein is not to be taken as an acknowledgement that such prior art constitutes common general knowledge in the art.

### SUMMARY OF THE INVENTION

In accordance with a first aspect, the present invention provides a tackle for displacing a load, the tackle including: a hydraulic motor assembly for displacing a tensile member that is connectable to the load; and a hydraulic pump assembly to drive the hydraulic motor, which hydraulic pump assembly is manually operable for driving the pump.

Preferably, the hydraulic pump assembly may include a hydraulic pump and a manually operable driving arrangement that is arranged for permitting a user manually to drive the hydraulic pump.

Preferably, the hydraulic pump may be a bi-directional hydraulic pump, and the manually operable driving arrangement may be arranged for permitting a user to manually drive the hydraulic pump bi-directionally. The hydraulic pump may be a rotary hydraulic pump having a drive shaft, and the manually operable driving arrangement may include an endless chain for cooperating with a complementary sprocket that is mounted towards a driven end of the drive shaft of the rotary hydraulic pump. The hydraulic pump may be any one of a fixed displacement pump and a variable displacement pump. The hydraulic pump may be a multi-cylinder pump, for example a three-cylinder pump.

In another embodiment, the manually operable driving arrangement may include a crank lever arrangement, a pawl and ratchet lever arrangement, or the like, for permitting a user to manually drive the hydraulic pump.

Preferably, the hydraulic pump assembly may include a hydraulic torque controller for de-stroking the hydraulic pump as the load increases.

Alternatively, the hydraulic motor assembly may include a hydraulic torque controller for stroking-on of the motor as the load increases. The hydraulic torque controller may be configured to de-stroke the hydraulic pump completely when an overload condition occurs, so as to resist damage that may be caused to the tackle as a result of the overloading condition.

Preferably, the tackle may include at least one load holding checkvalve that may be configured for resisting rotation of the hydraulic motor under influence from the load, until the hydraulic pump is operated which provides a pilot feed to override the load holding checkvalve.

Preferably, the tackle may also include a relief valve for relieving pressure when the hydraulic motor is overloaded, also to resist damage that may be inflicted onto the tackle by overloading. The relief valve may be configured for automatically lowering a load when an overload condition occurs to restore the working pressure of the motor to a safe pressure threshold.

Preferably, the tackle may also include a neutral valve which when actuated enables free rotation of the hydraulic motor so that the tensile member may be manually displaced when required. The neutral valve may be configured only to permit free rotation of the motor under no load conditions, and automatically to reset when a loading of the tackle increases above a loading threshold.

Preferably, the tackle may also include a load indicator. The load indicator may be configured to retain an indication of a maximum load to which the tackle has been subjected to. In addition, the load indicated may be configure to form a weight indicator for indicating in real time the load to which the tackle is subjected. The load indicator may include a load gauge. The load indicator may be interfaced with an audible or visual alarm.

Preferably, the tackle may also include at least one power take off (PTO) valve for interfacing with an external hydraulic drive pump to drive the hydraulic motor. The at least one PTO valve may include two PTO valves that are configured to permit bi-directional rotation of the hydraulic motor.

Preferably, the tackle may include a reduction gearbox fitted to the hydraulic motor. The reduction gearbox may include a planetary gearbox.

### BRIEF DESCRIPTION OF THE DRAWINGS

Embodiments of the invention are now described by way of example with reference to the accompanying drawings in which:

FIG. 1 shows a three-dimensional view of a tackle, in accordance with the invention;

FIG. 2 shows a three-dimensional view of another embodiment of a tackle, in accordance with the invention;

FIG. 3 shows a schematic diagram of a hydraulic circuit for a tackle in FIG. 1 Or FIG. 2;

FIG. 4 shows a schematic diagram of another hydraulic circuit for a tackle;

FIG. 5 shows a schematic diagram of another hydraulic circuit for a tackle;

FIG. 6 shows a schematic diagram of another hydraulic circuit for a tackle;

FIG. 7 shows a schematic diagram of another hydraulic circuit for a tackle;

FIG. 8 shows a schematic diagram of another hydraulic circuit for a tackle;

FIG. 9 shows a schematic diagram of another hydraulic circuit for a tackle;

FIG. 10 shows a schematic diagram of another hydraulic circuit for a tackle; and

FIG. 11 shows a three dimensional view of another embodiment of the tackle in accordance with the present invention.

### DETAILED DESCRIPTION OF THE PREFERRED EMBODIMENT

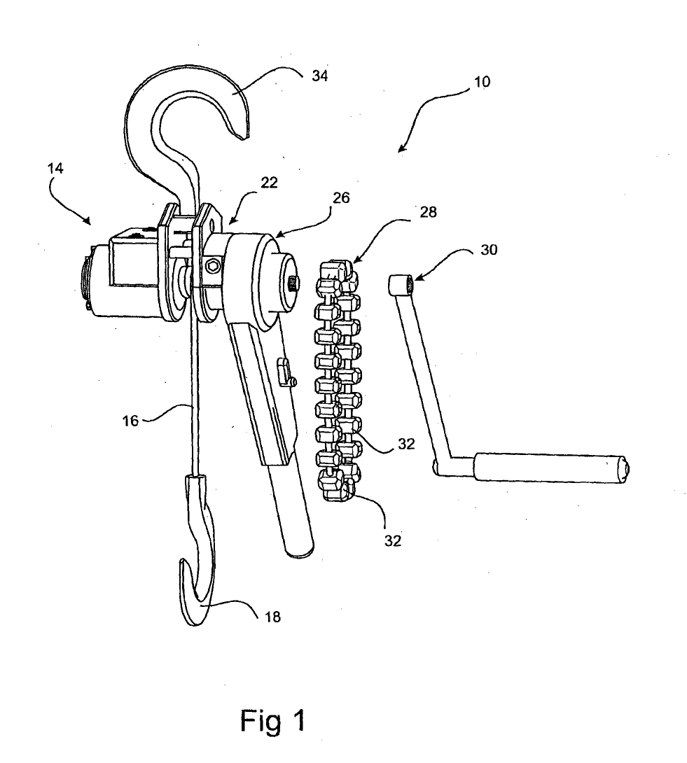

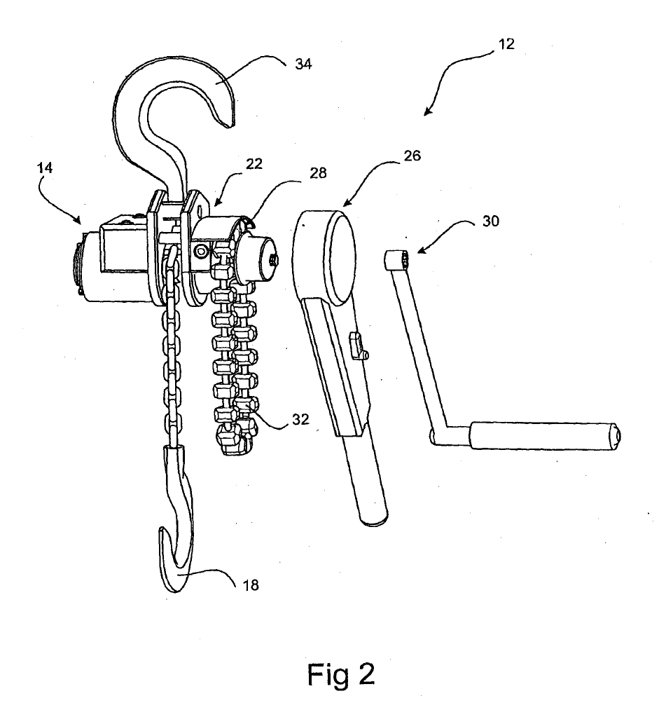

In the drawings, reference numeral 10 and 12 generally indicates tackles, in accordance with the invention, for use in displacing loads. In particular, the tackles 10 and 12 shown in FIGS. 1 and 2 are in the form of hoists.

Broadly the hoist 10 includes a hydraulic motor assembly 14 for displacing a tensile member 16 that is connectable to the load (not shown). The hydraulic motor assembly 14 includes a hydraulic motor 20 having a drive shaft. The tensile member 16 in this embodiment is in the form of a cable and includes a hook 18 toward its free end for connecting to the load. An opposite end of the cable 16 is attached to the drive shaft of the hydraulic motor 20 for winding the cable 16.

The hoist 10 further includes a hydraulic pump assembly 22 to drive the hydraulic motor 20. The hydraulic pump assembly 22 is manually operable.

The hydraulic pump assembly 22 includes a hydraulic pump 24 and a manually operable driving arrangement, of which three embodiments are shown in FIGS. 1 and 2 and generally indicated by reference numerals 26, 28, and 30 that are arranged for permitting a user manually to operate the hydraulic pump 24.

One manually operable driving arrangement 26 is in the form of a pawl-and ratchet assembly that includes a latch for switching direction of rotation.

The other manually operable driving arrangement 28 includes a cog-and-chain assembly. The chain is in the form of an endless chain that includes spaced apart generally square box-shaped gripping formations 32.

The other manually operable driving arrangement 30 includes a crank handle that uses a splined spigot and socket formation for attaching to a drive shaft of the hydraulic pump 24.

According to a further embodiment the manually operable arrangement 26, 28 and 30 may be replaced with a bi-directional pneumatic or electric motor for permitting a user to control or operate the hydraulic pump 24 instead of the manual control. This may be performed by the use of a pendant and cable attached to the bi-directional motor or via a wireless remote control to automatically control the operation of the bi-directional motor and hence the hydraulic pump 24.

Another hook 34 is attached to a body of the hoist 10 for suspending the hoist 10 from a support.

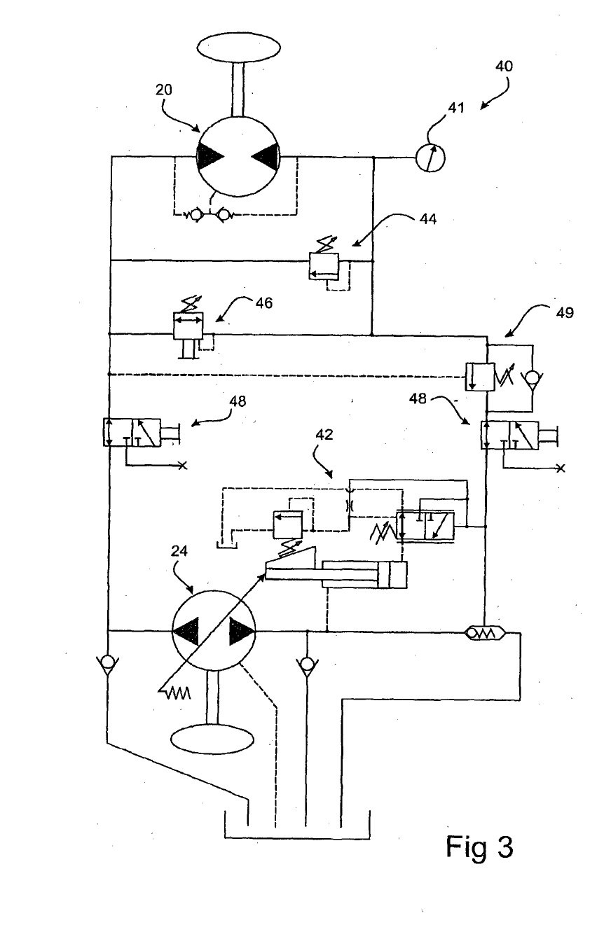

FIG. 3 shows a schematic diagram of a hydraulic circuit 40 for the tackle 10. The hydraulic circuit 40 includes a variable displacement bi-directional rotary hydraulic pump 24.

A hydraulic torque controller 42 is operatively connected to the hydraulic pump 24 for de-stroking the hydraulic pump 24 as the load on the hydraulic motor 20 increases. The hydraulic torque controller 42 is configured to de-stroke the hydraulic pump 24 completely when the load increases beyond a set threshold, so as to resist overloading of the hoist 10.

Moreover, the hoist 10 includes a load holding check valve 49 for resisting rotation of the hydraulic motor until the hydraulic pump 24 is operated which then provides a pilot feed to open the checkvalve.

The tackle may also include a cross-port relief valve 44 for relieving pressure when the hydraulic motor 20 is overloaded to resist damage from overloading.

A neutral valve 46 is provided, which when actuated enables free rotation of the hydraulic motor. The neutral valve 46 is configured so that it permits the motor to rotate freely as long as load conditions are below a safe threshold. The hoist 10 further includes a load indicator in the form of a load gauge 41 which is configured to indicate a historic maximum load to which the hoist 10 was subjected as well as provide an indication of real-time loading.

The hoist 10 also includes two power take off valves for interfacing with an external hydraulic drive pump and is configured for bi-directional driving of the hydraulic motor 20.

The hoist 10 also includes a reduction planetary gearbox (not shown) fitted to the hydraulic motor 20 and housed by the body of the hoist 10.

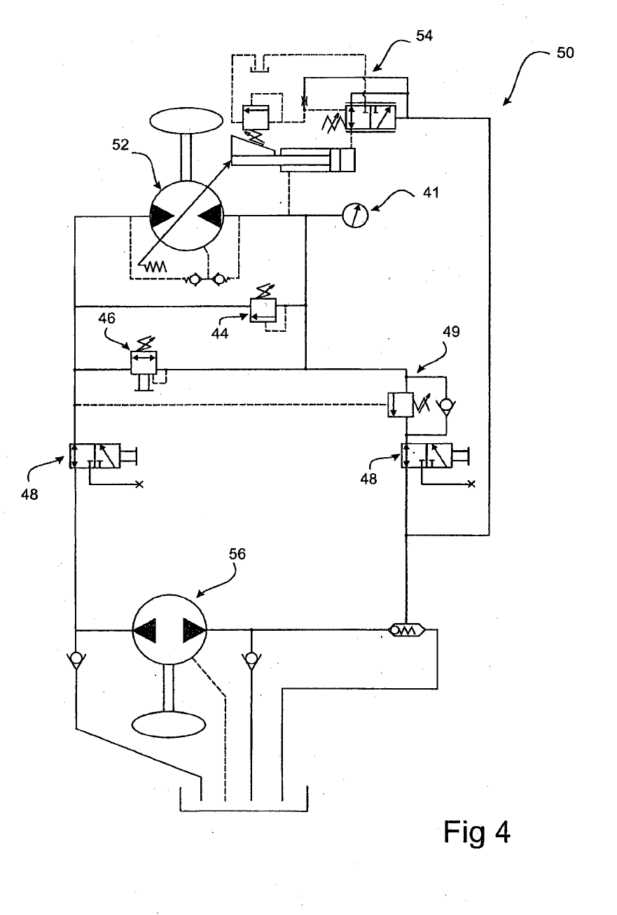

FIG. 4 shows a schematic diagram of another hydraulic circuit 50 for a tackle 10. The hydraulic circuit 50 is essentially identical to the hydraulic circuit shown in FIG. 3, and like parts are indicated with like reference numerals used in FIG. 3. In this embodiment, hydraulic pump 56 is a fixed displacement pump and the hydraulic motor 52 is a variable displacement motor which is operatively connected to the hydraulic torque controller 54.

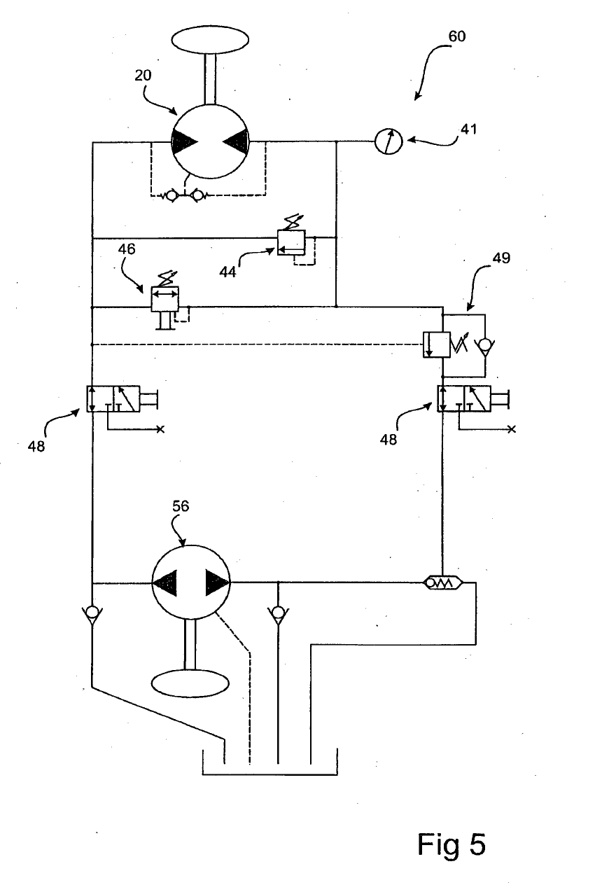

FIG. 5 shows a schematic diagram of another hydraulic circuit 60 which includes a fixed displacement hydraulic pump 56 and a fixed displacement hydraulic motor 20, without a hydraulic torque controller.

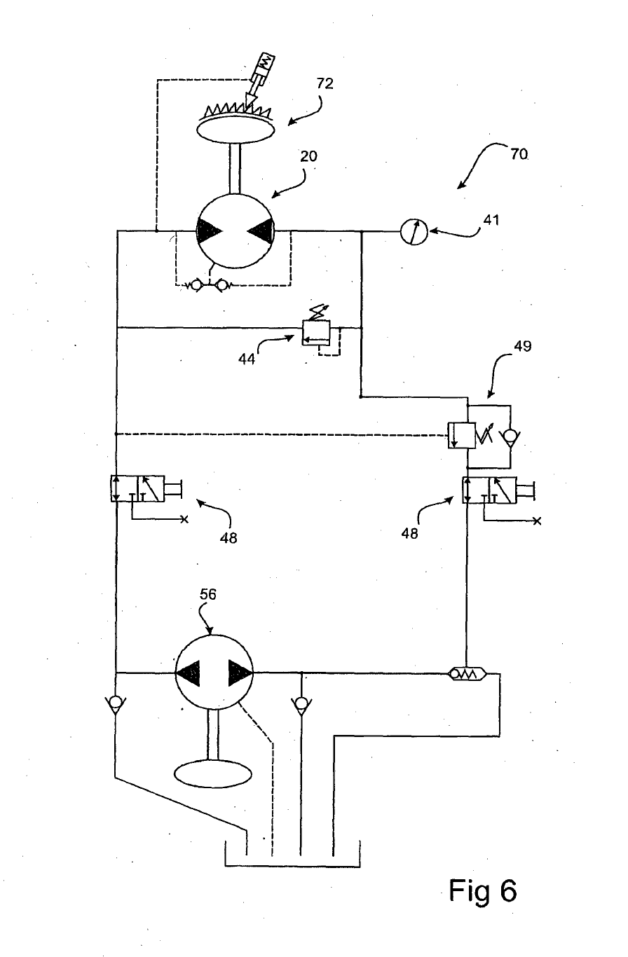

FIG. 6 shows a schematic diagram of another hydraulic circuit 70 which is essentially similar to the hydraulic circuit 60 in FIG. 5, and also includes a hydraulically controlled ratchet 72 for resisting rotation of the hydraulic motor when the hydraulic motor 20 is not being driven.

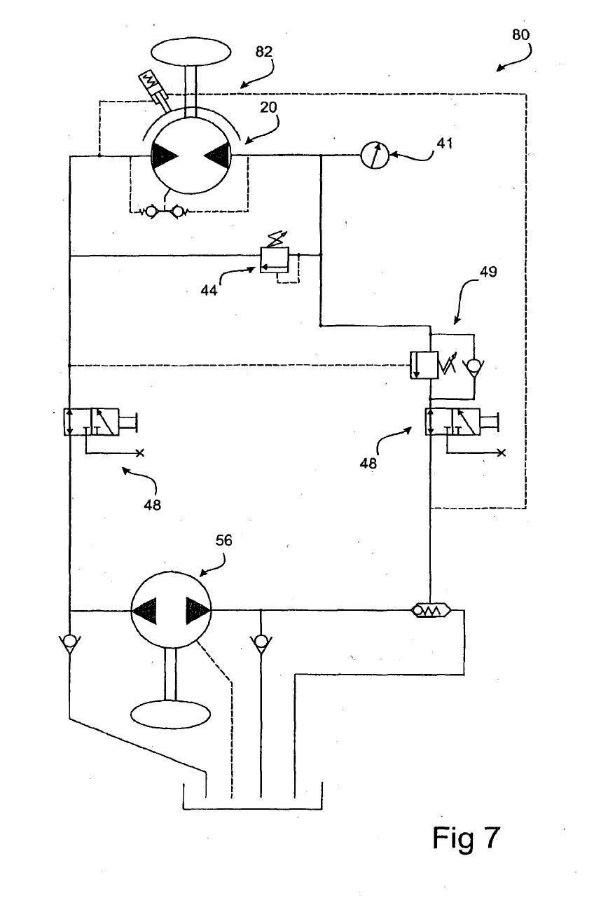

FIG. 7 shows a schematic diagram of another hydraulic circuit 80 which is essentially similar to the hydraulic circuit 60 in FIG. 5, and also includes a hydraulically controlled brake 82 for resisting rotation of the hydraulic motor 20 when the hydraulic motor 20 is not being driven.

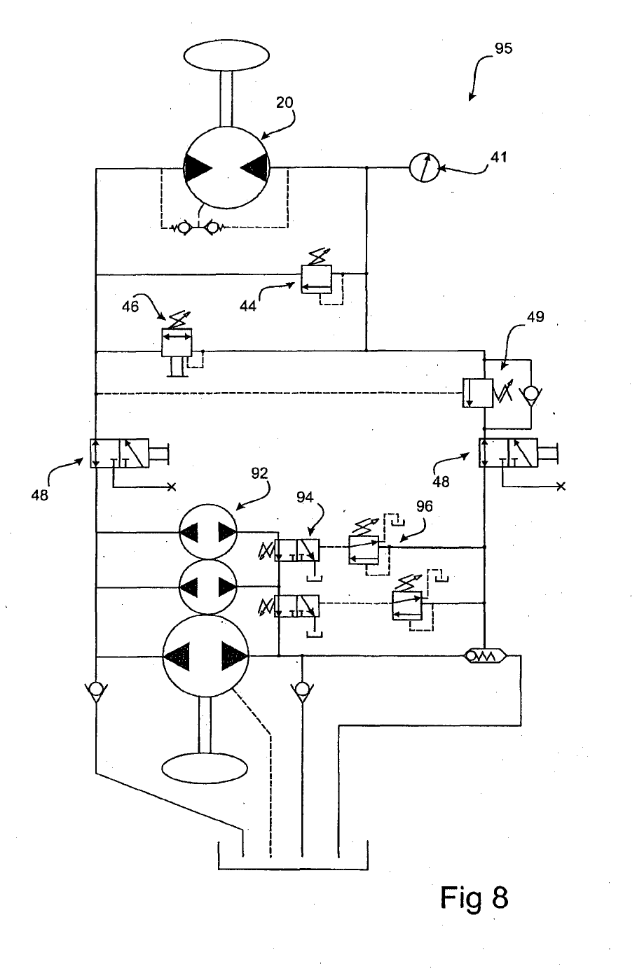

FIG. 8 shows a schematic diagram of another hydraulic circuit 95 which is similar to the hydraulic circuit 60 in FIG. 5, but includes a plurality of hydraulic pumps 92 in the form of three fixed displacement pumps. The pumps 92 form a three stage pump circuit. It follows that the flow from the pump arrangement can be reduced to reduce the effective load experienced by the user. The less flow being produced by the pumps, the easier it is for a user to drive the motor, so high pressures can be achieved with low flow.

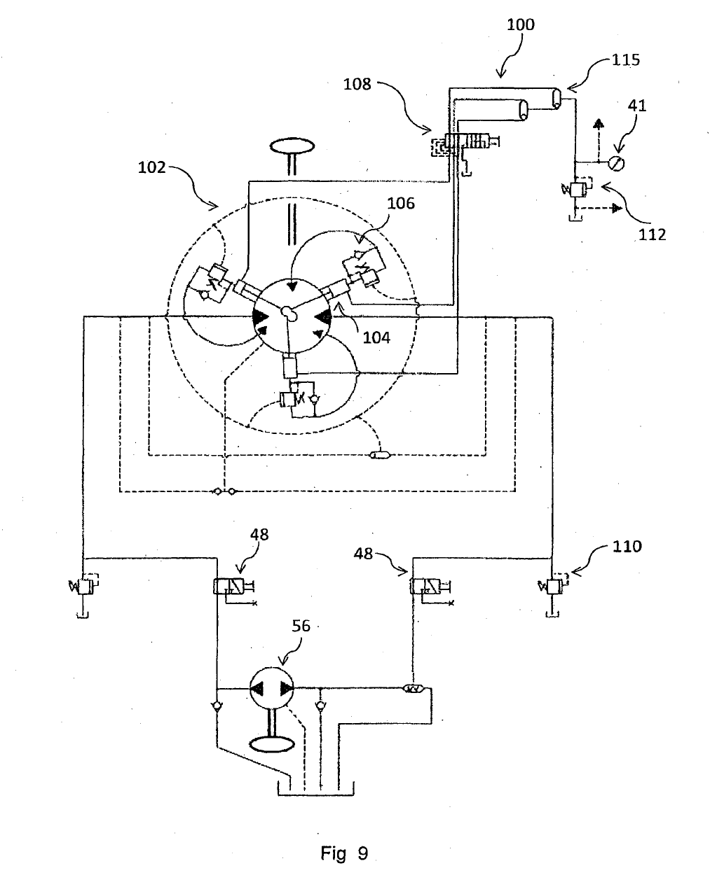

FIG. 9 shows a schematic diagram of another hydraulic circuit 100 which includes a three cylinder bi-directional hydraulic motor 102. The circuit 100 also includes for each cylinder of the motor an associated load holding check valve 106.

The neutral valve 108 in this embodiment is in the form of a hand-operated control valve. Each cylinder of the motor 102 is connected to valve 108 which when activated allows free rotation of the motor. Moreover, a sudden or impact loading applied to the motor 102 will cause the valve 108 to reset. Further, shuttle valves 115 are provided selectively to allow flow from the line having the highest cylinder pressure for operating the gauge 41 and overpressure relief valve 112.

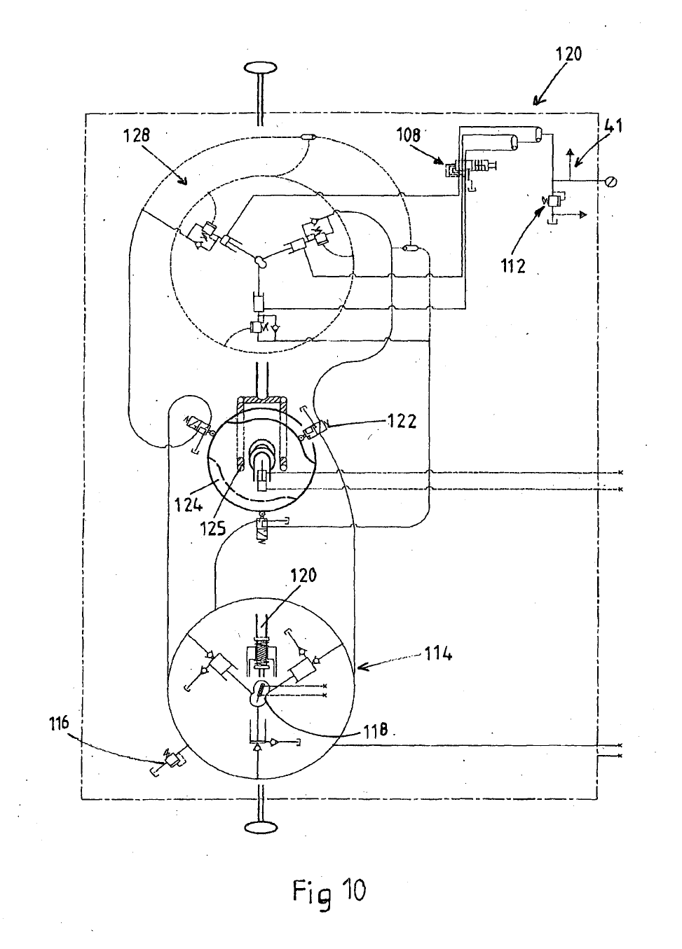

FIG. 10 shows a schematic diagram of another hydraulic circuit 120 which includes similarities to the hydraulic circuit 100. The hoist housing hydraulic circuit 120 includes a timing plate 124 which is axially displaceable with a threaded shaft extending through the pump 114, which when turned displaces the timing plate 124 axially to-and-fro, as the case may be.

The timing plate 124 defines three outer edge profiles. In neutral position, a circular outer edge profile of the timing plate 124 closes the valves 122 and thus blocks flow from the pump 114. When the timing plate 124 is axially displaced in one direction, another side edge profile operates the valves 122 in a manner that allows the flow to operate the motor in one direction, and when axially displaced towards that other direction it operates the valves 122 in a manner that allows the flow to operate the motor in the opposite direction.

It follow, that the operator drives the shaft 120 which effectively sets the timing of the motor before driving the pump 114. A servo piston 118 is used to control the displacement of the pump 114. Effectively the servo piston 118 is comparable with a torque controller pump in that it makes the pump a variable displacement pump and is therefore similar to a transmission. The servo piston 118 can be controlled with a torque controller or spring. The timing plate 124 is controlled by the drive shaft 120 but not fixedly mounted thereto, but actually rotates with the motor at the same direction and speed by way of the two or more dowels 125 effectively locking the timing plate in unison with the motor.

In use, when a user wishes to displace a load, for example hoisting a load with hoist 10 incorporating the hydraulic circuit in FIG. 3, the user suspends the hoist 10 with the hook 34 from a support. If required, the neutral valve 46 can be actuated so that the user can easily extend the rope or chain for attaching hook 18 to the load, after which the neutral valve 46 is reset.

The chain 28 is then operated for driving the hydraulic pump manually which drives the hydraulic motor to hoist the load.

Whenever driving of the hydraulic pump stops, then a pilot feed to the load holding check valves also stops which resists free flow of the hydraulic fluid through the hydraulic motor, and therefore resists rotation of the motor which holds the position of the load until the pump is driven again by the user.

Also, as the load increases the hydraulic torque controller de-strokes the pump to facilitate lifting of the load, not unlike a reduction gearbox.

When the hoist 10 is subjected to an overload condition, the pressure relief valve 44 opens to reduce the pressure to a safe threshold.

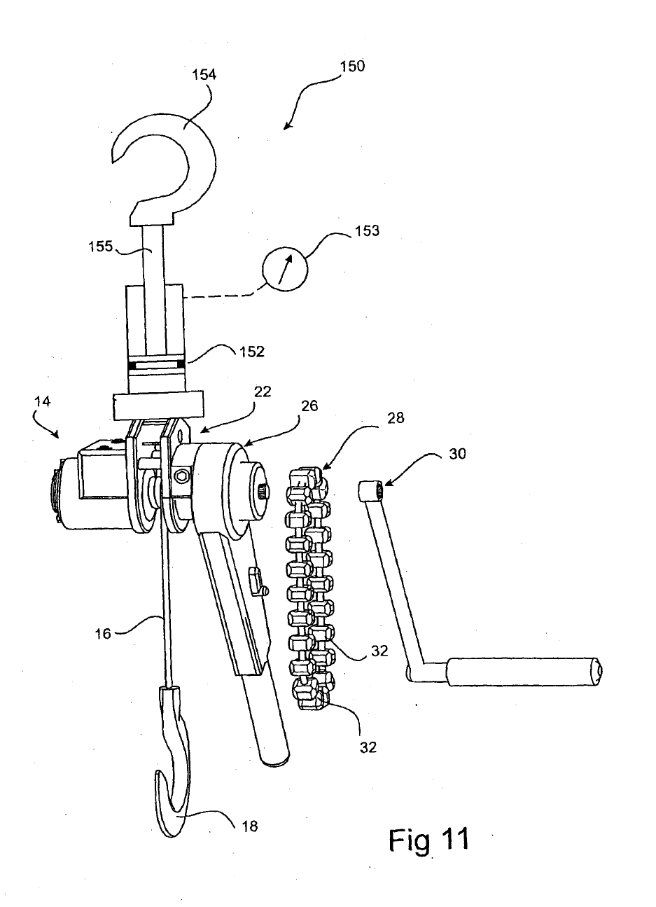

FIG. 11 shows a further embodiment of the present invention in which a hoist 150 with a hook 154 mounted to the body of the hoist 150, the hook 154 allowing the hoist 150 to be mounted to a structure, in use. The hook assembly can be permanent or removable 154 and consists of a hook attached to a longitudinal shaft or tube 155 which at its lower extremity is attached to a piston 152 within a hydraulic cylinder. The base of the hook assembly is attached to the hoist 150.

The implementation of the hydraulic cylinder, piston 152 and shaft 155 incorporates a load indicator which is configured to provide an indication of the real-time display of the weight indication of the load attached to the tensile member 16 to indicate the weight on a load gauge 153. For example, as the load on the tensile member 16 increases the load indicator wants to pull apart which increases the hydraulic pressure in the cylinder which is then transferred to the gauge 153 to provide an indication of the weight/load on the tensile member 16.

The gauge 153 for indicating the weight/load on the tensile member 16 may be a simple hydraulic pressure gauge or may incorporate a transducer and sensor used in combination with an electronic or analog weight/load gauge. It should be understood that any combination of transducer, sensor or gauge could be used to indicate the weight on the tensile member 16. Also, the gauge or indicator may also incorporate a form of historic load indication which can monitor and record the highest load applied to the hoist 150 which is especially important for any maintenance of the hoist. Furthermore, the hoist 150 could be fitted with more than one gauge 153 in order to provide more accurate readings for example 0-50 kg, 50-100 kg and so on. It also possible to incorporate an audible or visual alarm for provide a warning should the maximum load rating of the hoist be exceeded.

### ADVANTAGES

Advantageously, the hoists 10, 12 is manually or hand-operated and hydraulically driven.

Another advantage of the hoists 10, 12 is that it includes the hydraulic torque controller for reducing displacement of the hydraulic pump as the load increases, which makes it easier to hoist loads as the load increases, and also permits greater or full displacement when there is no load for paying out the tensile member faster under no load conditions.

The load indicator, such load gauge 41, enables the user to view an indication of the amount of load that the hoist is subjected to, and provides the advantage of showing the historic maximum load to which the hoist 10 was subjected.

The load holding check valve 49 also provides a safety advantage, by resisting rotation of the hydraulic motor until the hydraulic pump 24 is operated, which for example avoids uncontrolled displacement of a load under gravity.

Another advantage in particular of the hoist having the hydraulic circuit 120, is that the hoist can be constructed relatively compact in the form of an enclosed unit having a single case which also acts as the reservoir. Moreover, the timing plate and valve design remove the chance of cross-port leakage, and therefore effectively increases the efficiency of the motor. Cross-port leakage is a common problem with hydraulic motors, which reduces their efficiency due to internal leakage.

Further advantages of the hoists as described, includes:
the use of pressure relieve valves and/or variable displacement pumps reduce the risk of damage that may be caused to the hoist as a result of overloading;
the load gauge with an overload dial and/or an overload relief with audible and visual alarm provides an additional safety feature including a historic load record (a user won't use the device if it has been overloaded in past uses-prestart check)
the variable displacement/speed motor can functionally achieve similar functionality as a transmission;
more than one pump or motor can be used to achieve similar functionality as a transmission;
the PTO ports for use with an external power source also isolates the drive mechanism;
a reduction gearbox can be operatively fitted to the motor for accommodating larger loads;
ergonomic square notched rope which allows the user to easily grip and control the manual drive of the hydraulic pump. The square notch allows the user to comfortably grip the chain and control the lifting of an item;
a compact design; and
can be fitted with small low power or high speed motor (pneumatic or electric) because of the transmission design of the unit.

### VARIATIONS

In this specification the term tackle is used in a broad sense to include hoists, chain blocks, winches, capstans, and the like.

It will be realized that the foregoing has been given by way of illustrative example only and that all other modifications and variations as would be apparent to persons skilled in the art are deemed to fall within the broad scope and ambit of the invention as herein set forth. Throughout the description and claims of this specification the words “comprise” and variations of that word such as “comprises” and “comprising” are not intended to exclude other additives components integers or steps.

1. A tackle for displacing a load, the tackle including:
a hydraulic motor assembly for displacing a tensile member that is connectable to the load; and
a hydraulic pump assembly to drive the hydraulic motor, which hydraulic pump assembly is manually operable for driving the pump.

2. A tackle as claimed in claim 1, wherein the hydraulic pump has a manually operable driving arrangement that is arranged for permitting a user manually to drive the hydraulic pump.

3. A tackle as claimed in claim 1 or claim 2, wherein the hydraulic pump is a bi-directional hydraulic pump, and the manually operable driving arrangement is arranged for permitting a user to manually drive the hydraulic pump bi-directionally.

4. A tackle as claimed in claim 3, wherein the hydraulic pump is a rotary hydraulic pump having a drive shaft, and the manually operable driving arrangement includes an endless chain for cooperating with a complementary sprocket that is mounted towards a driven end of the drive shaft of the rotary hydraulic pump.

5. A tackle as claimed in any one of the preceding claims, wherein the hydraulic pump is any one of a fixed displacement pump or a variable displacement pump.

6. A tackle as claimed in claim 5, wherein the hydraulic pump is a multi-cylinder pump, such as a three-cylinder pump.

7. A tackle as claimed in any one of claims 2 to 4, wherein the manually operable driving arrangement is a crank lever arrangement, or a pawl and ratchet lever arrangement, or the like, for permitting a user to manually drive the hydraulic pump.

8. A tackle as claimed in claim 7, wherein the manually operable driving arrangement is a chain with square box like links.

9. A tackle as claimed in any one of the preceding claims, wherein the hydraulic pump assembly includes a hydraulic torque controller for de-stroking the hydraulic pump as the load increases.

10. A tackle as claimed in any one of the preceding claims, wherein the hydraulic motor assembly includes a hydraulic torque controller for stroking-on of the motor as the load increases.

11. A tackle as claimed in claim 10, wherein the hydraulic torque controller is configured to de-stroke the hydraulic pump completely when an overload condition occurs, so as to resist damage that may be caused to the tackle as a result of the overloading condition.

12. A tackle as claimed in any one of the preceding claims, wherein the tackle includes at least one load holding check valve that is configured for resisting rotation of the hydraulic motor under influence from the load, until the hydraulic pump is operated which providing a pilot feed to override the load holding check valve.

13. A tackle as claimed in any one of the preceding claims, wherein the tackle includes a relief valve for relieving pressure when the hydraulic motor is overloaded, also to resist damage that may be inflicted onto the tackle by overloading.

14. A tackle as claimed in claim 13, wherein the relief valve is configured for automatically lowering a load when an overload condition occurs to restore the working pressure of the motor to a safe pressure threshold.

15. A tackle as claimed in any one of the preceding claims, wherein the tackle includes a neutral valve which when actuated enables free rotation of the hydraulic motor so that the tensile member is manually displaced when required.

16. A tackle as claimed in claim 15, wherein the neutral valve is configured only to permit free rotation of the motor under no load conditions, and automatically to reset when a loading of the tackle increases above a loading threshold.

17. A tackle as claimed in any one of the preceding claims, wherein the tackle includes a load indicator.

18. A tackle as claimed in claim 17, wherein the load indicator may be configured to retain an indication of a maximum load to which the tackle has been subjected to.

19. A tackle as claimed in claim 17 or claim 18, wherein the load indicator is configured to form a weight indicator for indicating in real time the load to which the tackle is subjected.

20. A tackle as claimed in any one of claims 17 to 19, wherein the load indicator includes a load gauge, wherein the load indicator is interfaced with an audible or visual alarm.

21. A tackle as claimed in any one of claims 17 to 20, wherein the tackle includes an upper hook mounted to the body of the tackle for mounting the body to a structure, in use, wherein the load indicator is mounted between the upper hook and the body of the tackle.

22. A tackle as claimed in any one of the preceding claims, wherein the tackle includes at least one power take off (PTO) valve for interfacing with an external hydraulic drive pump to drive the hydraulic motor.

23. A tackle as claimed in claim 22, wherein the at least one PTO valve includes two PTO valves that are configured to permit bi-directional rotation of the hydraulic motor.

24. A tackle as claimed in any one of the preceding claims, wherein the tackle includes a reduction gearbox fitted to the hydraulic motor.

25. A tackle as claimed in claim 24, wherein the reduction gearbox includes a planetary gearbox.

26. A hoist for displacing a load, the hoist including:
a hydraulic motor assembly for displacing a tensile member that is connectable to the load;
a containment unit for retaining the tensile member around a drum where the tensile member is contained until the hoist is lowered;
a shaft operatively associated with the drum to rotatably mount the drum to the hydraulic motor assembly;
a load attachment member for attaching the load to the tensile member;
an upper hook mounted at a top of the hoist for mounting the hoist to a structure, in use; and
a hydraulic pump assembly to drive the hydraulic motor, which hydraulic pump assembly is manually operable for driving the pump.

27. A hoist as claimed in claim 26, the hoist including a tackle in accordance with any one of claims 1 to 25.
